(19) United States
(12) Patent Application Publication
(10) Pub. No.: US 2026/0128526 A1
(43) Pub. Date: May 7, 2026

(54) HEAD-MOUNTED ELECTRONIC DEVICE AND ANTENNA STRUCTURE

(71) Applicant: Goertek Inc., Weifang, Shandong (CN)

(72) Inventor: Kenichiro Kodama, Shandong (CN)

(73) Assignee: Goertek Inc., Weifang, Shandong (CN)

(21) Appl. No.: 19/117,508

(22) PCT Filed: Jan. 4, 2023
(86) PCT No.: PCT/CN2023/070295

§ 371 Date: Apr. 1, 2025

(51) Int. Cl. H01Q 9/42; H01Q 1/27; H01Q 5/10

(52) U.S. Cl. CPC H01Q 9/42; H01Q 1/273; H01Q 5/10

(57) ABSTRACT

A head-mounted electronic device worn by a user and an antenna structure are provided. The head-mounted electronic device comprises the antenna structure and housing, where the antenna structure is configured to transmit or receive wireless signals and is located at a portion of the housing. The portion protrudes away from a head of the user. The antenna structure may comprise a first electrode and a second electrode located at different sides of a feeding point, where the first electrode and the second electrode serve as at least a part of a first antenna and at least a part of the second antenna, respectively, and are configured to transmit or receive the wireless signals of different frequencies.

This application is a National Stage of International Application No. PCT/CN 2023/070295, filed on Jan. 4, 2023, which is hereby incorporated by reference in its entirety.

### TECHNICAL FIELD

The present disclosure relates to the technical field of wireless devices, and in particular, to a head-mounted electronic device and an antenna structure.

### BACKGROUND

Recent decades have witnessed prosperity of electronic wearable devices. Being designed properly, these devices are generally not handheld during usage, but are “worn” as accessories or even apparel on body parts of a user, i.e. a wearer. Hence, it is quite convenient for the wearer to interact with the outside world simultaneously in various manners. For example, the virtual reality (VR) or augmented reality (AR) technology may apply electronic headwear to provide visual and/or acoustic information, while the wearer is able to operate a keyboard or a gamepad by hand. For another example, an electronic wristband may collect electro-cardio signals of the wearer, while not interrupting daily activities of the wearer. For another example, electronic eyeglasses may prompt the wearer with detailed content of instant messages, even when both bands of the wearer are occupied. Since visual signals and acoustic signals are most common among all kinds of information received by human beings, many electronic wearable devices are head-mounted to facilitate interaction with the eyes, the ears, and the vocal organs of the wearers, or to provide a vivid imitation on wearers'real perception.

Rapid development of the batteries and the integrated circuits renders electronic wearable devices smaller sizes and more compact structures, which aims at merging them into each application scenario in people's daily life. Therefore, an increasing requirement on convenient “anytime and anywhere” accesses to the Internet and WLANs demands the electronic wearable devices wireless and portable. A prospect is that the electronic wearable devices are capable to provide high-quality wireless accesses while not causing an impact on an electromagnetic environment of other components in the device. For example, an AR/VR head-mounted display should be no larger and no heavier than ordinary eyeglasses or goggles. Such objective raises great challenges on a robust design of the electronic wearable devices, especially the head-mounted devices.

### SUMMARY

In view of the above, a head-mounted electronic device and an antenna structure are provided according to embodiments of the present disclosure, so as to reduce an impact of a human body, especially a head, on wireless communication of the head-mounted electronic device.

Following technical solutions are provided to achieve the above technical objective.

In one aspect, a head-mounted electronic device is provided, comprising: an antenna structure, configured to transmit or receive wireless signals, and a housing, where the antenna structure is located at a portion of the housing, and the portion protrudes away from a head of a user when the head-mounted electronic device is worn by the user.

In one embodiment, the portion is farthest from a head of a user, among a local part which is of the housing and at which the portion is located, when the head-mounted electronic device is worn by the user.

In one embodiment, the portion is farthest from a head of a user, among all portions which protrude away from the head in the housing, when the head-mounted electronic device is worn by the user.

In one embodiment, the antenna structure comprises: a first electrode, located at a side of a feeding point; and a second electrode, located at another side of a feeding point; where the first electrode serves as at least a part of a first antenna fed from the feeding point, the second electrode serves as at least a part of a second antenna fed from the feeding point, and the first antenna and the second antenna are configured to transmit or receive wireless signals of different frequencies.

In one embodiment, the first antenna and the second antenna are of different antenna types.

In one embodiment, the different antenna types are from a monopolar antenna, a slot antenna, a loop antenna, an inverted-L antenna, an inverted-F antenna, and a meander antenna.

In one embodiment, one or both of the first electrode and the second electrode are conductive films located on a metal frame, a flexible printed circuit or a laser-direct-structured material.

In one embodiment, the housing comprises: a first component disposed in front of the head of the user when the head-mounted electronic device is worn by the user; and a second component disposed at either right or left of the head when the head-mounted electronic device is worn by the user; where an end of the first component and an end of the second component are physically connected at a junction.

In one embodiment, the junction serves as the portion of the housing.

In one embodiment, the housing is flexible at the junction; the RF chip is electrically connected to at least one of the first antenna and the second antenna in response to an angle between a surface of the first component and a surface of the second component being within a first range; and the RF chip is electrically disconnected from the at least one of the first antenna and the second antenna in response to the angle being not within the first range.

In one embodiment, one of the first electrode and the second electrode is disposed at the end of the first component, and another of the first electrode and the second electrode is disposed at the end of the second component.

In one embodiment, the feeding point is located between the end of the first component and the end of the second component.

In one embodiment, both the first electrode and the second electrode are disposed at the end of the first component, or at the end of the second component.

In one embodiment, the first electrode is located within a plane parallel with or perpendicular to a surface of the housing, and the second electrode is located within another plane parallel with or perpendicular to the surface of the housing.

In one embodiment, the head-mounted electronic device further comprises a lens disposed in front of an eye of the user when the head-mounted electronic device is worn by the use, where the antenna structure is adjacent to the lens.

In one embodiment, the housing comprises a lens frame configured to fix the lens to the housing, and at least a part of the antenna structure is attached to the lens frame.

In one embodiment, at least a part of the first electrode is disposed adjacent to the lens and is conformed to an edge of the lens or to the lens frame.

In one embodiment, at least a part of the second electrode and the part of the first electrode extend along the edge or the lens frame in different directions.

In one embodiment, at least one of the first electrode and the second electrode is conformed to a surface of the lens.

In one embodiment, the head-mounted electronic device further comprises a conductive bracket configured to mount a functional apparatus on the housing, where: the antenna structure is attached to the housing via the conductive bracket, and the conductive bracket serves as a ground for the first antenna and the second antenna.

In one embodiment, the functional apparatus comprises a projector, which is configured to project an image on to the lens.

In one embodiment, the antenna structure is directly attached to a conductive portion of the housing, and the conductive portion serves as a ground for the first antenna and the second antenna.

In one embodiment, the head-mounted electronic device comprises electronic eyeglasses, where portion of the housing is located between a temple bar and the lens frame.

In another aspect, an antenna structure is further provide, comprising: a first electrode, located at a side of a feeding point; and a second electrode, located at another side of a feeding point; where the first electrode serves as at least a part of a first antenna fed from the feeding point, the second electrode serves as at least a part of a second antenna fed from the feeding point, and the first antenna and the second antenna are configured to transmit or receive wireless signals of different frequencies.

The head-mounted electronic device and the antenna structure are provided according to embodiments of the present disclosure. The head-mounted electronic device comprises the antenna structure and the housing. The antenna structure is configured to transmit or receive wireless signals and is located at the portion of the housing. The portion protrudes away from the head of the user when the head-mounted electronic device is worn by the user. Since the antenna structure is disposed farthest or locally farthest from the head of the user in the housing, a large portion of the wireless signals propagates through free space without being influenced by the human body. Hence, the wireless signals are less attenuated and quality of wireless communications is improved during usage of the head-mounted electronic device. Moreover, the antenna structure may comprise the first electrode located at one side of the feeding point and the second electrode located at the other side of the feeding point. The first electrode and the second electrode serve as at least the part of the first antenna and at least the part of the second antenna, respectively, and are configured to transmit or receive wireless signals of different frequencies. The first antenna and the second antenna sharing the same feeding point while locating at different sides of the feeding point are capable to reduce a space occupied by the dual-band antenna to the most extent while ensuring quality of wireless signals.

### BRIEF DESCRIPTION OF THE DRAWINGS

For clearer illustration of the technical solutions according to embodiments of the present disclosure or conventional techniques, hereinafter briefly described are the drawings to be applied in embodiments of the present disclosure or conventional techniques. Apparently, the drawings in the following descriptions are only some embodiments of the present disclosure, and other drawings may be obtained by those skilled in the art based on the provided drawings without creative efforts.

FIG. 1a is a schematic structural diagram of a head-mounted electronic device when being worn by a user according to an embodiment of the present disclosure.

FIG. 1b is a schematic structural diagram of a head-mounted electronic device according to another embodiment of the present disclosure.

FIG. 2a is a schematic structural diagram of an antenna structure according to an embodiment of the present disclosure.

FIG. 2b is a schematic structural diagram of an antenna structure according to another embodiment of the present disclosure.

FIG. 2c is a schematic structural diagram of an antenna structure according to another embodiment of the present disclosure.

FIG. 2d is a schematic structural diagram of an antenna structure according to another embodiment of the present disclosure.

FIG. 3 is a schematic structural diagram of a housing of a head-mounted electronic when being worn by a user according to an embodiment of the present disclosure.

FIG. 4a is a schematic structural diagram of an antenna structure disposed in a housing according to an embodiment of the present disclosure.

FIG. 4b is a schematic structural diagram of an antenna structure disposed in a housing according to another embodiment of the present disclosure.

FIG. 5 is a schematic structural diagram of a head-mounted electronic device when being worn by a user according to another embodiment of the present disclosure.

FIG. 6a is a schematic structural diagram of an antenna structure disposed at a lens or a lens frame according to an embodiment of the present disclosure.

FIG. 6b is a schematic structural diagram of an antenna structure disposed at a lens or a lens frame according to another embodiment of the present disclosure.

FIG. 7 is a schematic structural diagram of a head-mounted electronic device when being worn by a user according to another embodiment of the present disclosure.

FIG. 8 is a schematic stereoscopic view of a part of a head-mounted electronic device according to an embodiment of the present disclosure.

FIG. 9 is schematic diagrams of current distribution of an antenna structure fed under different frequencies according to an embodiment of the present disclosure.

FIG. 10 is a graph of antenna efficiency of antenna structure in different frequency bands according to an embodiment of the present disclosure.

### DETAILED DESCRIPTION OF THE EMBODIMENTS

Hereinafter technical solutions in embodiments of the present disclosure are described in conjunction with the drawings in embodiments of the present disclosure. The described embodiments are only some rather than all of the embodiments of the present disclosure. Any other embodiments obtained based on the embodiments of the present disclosure by those skilled in the art without any creative effort fall within the scope of protection of the present disclosure.

As described in the background, a requirement on the wireless and portable electronic wearable devices demands a compact design of components within the devices. Such requirement becomes stricter for a head-mounted electronic device, because a bulky and heavy head-mounted device would not only cause inconvenience during usage but also brings health risks, especially aggravating neck pains. Consequently, many head-mounted electronic devices try to dispose every component as close as possible to the user's head, such that the users would experience less discomforts due to the imbalanced additional weight when moving or turning their heads. Such design also brings the antenna quite close to a body of the user. For example, an antenna of electronic eyeglasses is disposed at a tip or an intermediate part of temple bar, which is close to an ear or a temple of the user. Since the human body creates an inductance of approximately 500 nH to 750 nH, it attenuates electromagnetic waves and results in reduced intensities and increased bit error rates of wireless signals that are transmitted or received by the antenna. Consequently, the wireless communication of the head-mounted electronic device is degraded.

In order to address the above technical issue, a head-mounted electronic device is provided according to embodiments of the present disclosure. The head-mounted electronic device comprises an antenna structure configured to transmit or receive wireless signals, and further comprises a housing, and is located at a portion of the housing. The portion protrudes away from a head of a user when the head-mounted electronic device is worn by the user. Since the antenna structure is disposed locally farthest from the head of the user, a large portion of the wireless signals propagates through free space without being influenced by the human body. Hence, the wireless signals are less attenuated and quality of wireless communications is improved during usage of the head-mounted electronic devices.

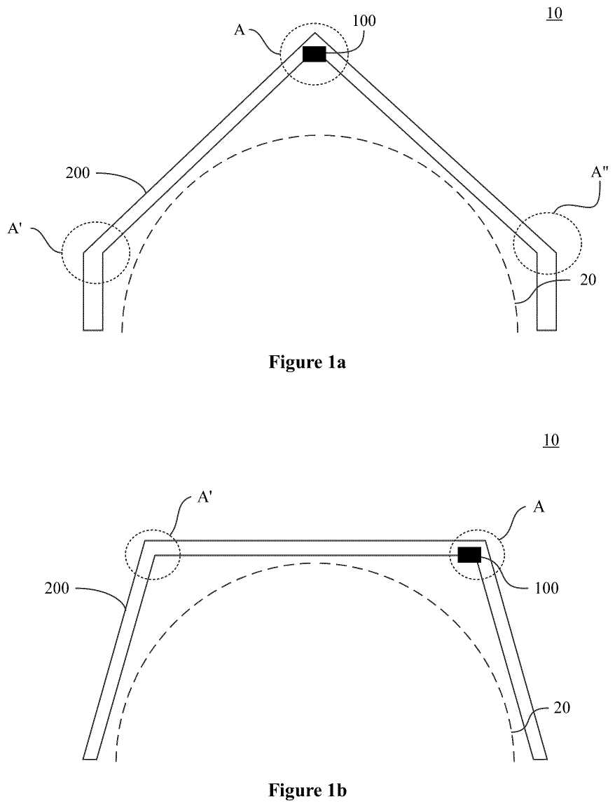

Reference is made to FIGS. 1a and 1b, which are schematic structural diagrams of head-mounted electronic devices 10 according to embodiments of the present disclosure. In both cases, the head-mounted electronic device 10 comprises an antenna structure 100 and a housing 200.

The antenna structure 100 is configured to transmit or receive wireless signals. Generally, the wireless signals are carried by electromagnetic waves having a frequency within a frequency band which is defined in a wireless communication standard. The frequency band and the wireless communication standard are not specifically limited herein, and may be determined according to an actual requirement. For example, the wireless communication standard is Wireless Fidelity (Wi-Fi), and the frequency band ranges from 2.4 GHz to 2.48 GHz, or from 5.15 GHz to 7.15 GHz. For another example, the wireless communication standard is Bluetooth®, and the frequency band ranges from 2.4 GHz to 2.485 GHz. For another example, the wireless communication standard is a wireless communication standard for cellular network, such as the 2G, 3G, 4G or 5G standard. In this embodiment, before transmitted or after received as electromagnetic waves, the wireless signals may be in a form of an oscillating current or an oscillating voltage at, for example, a radio-frequency (RF) connector for the antenna structure 100. The RF connector is configured to connect the antenna structure 100 electrically with RF circuitry, so that the FR circuitry provides a feed to the antenna structure 100. In practice, the RF connector may be implemented by on-board wires, an independent cable, or the like.

In some embodiments, the RF circuitry may be coupled with or may be a part of processing circuitry, and is configured to convert the oscillating current or the oscillating voltage into a signal compatible with a processing capability of the processing circuitry, or the vice versa. Generally, the conversion is implemented through modulation or demodulation. Specifically, the RF circuitry modulates the oscillating current or the oscillating voltage based on a signal generated by the processing circuitry, and then the antenna structure 100 converts the modulated oscillating current or the oscillating voltage into the wireless signals for transmission. Similarly, the antenna structure 100 coverts the received wireless signals into the oscillating current or the oscillating voltage, and the RF circuitry demodulates the oscillating current or the oscillating voltage to acquire a signal for processing at the processing circuitry. In this embodiment, the processing at the processing circuitry may include, but is not limited to, coding or decoding of visual signals, acoustic signals, or control signals. In practice, the processing circuitry may be implemented in various manners. For example, the processing circuitry may be an application specific integrated circuit (ASIC), a field-programmable gate array (FPGA), a special-purpose chip, or the like. For another example, the processing circuitry is an independent chip mounted on a printed circuit board (PCB), or may be integrated into another chip having multiple functions. The present disclosure is not limited to the above example, and any appropriate chip may serve as the processing circuitry as long as it is capable to process the wireless signals.

The RF circuitry and the processing circuitry are not depicted in Figures la and 1b. Each of the RF circuitry and the processing circuitry may or may not be a component comprised in the head-mounted electronic device. That is, the head-mounted electronic device may have a capability of signal processing, or may serve as a plug-in unit of another device capable of signal processing, which is not limited herein.

The housing 200 is configured to protect component(s) located therein. Although the housing 200 in FIGS. 1a and 1b are depicted as a hollow polygon for simplicity of illustration, those skilled in the art can appreciate the housing 200 may have various designs according to different target application scenarios in practice, and may have another part other than what is depicted in the figures. As an example, a surface of the housing 200 may be curved. As another example, a portion of the housing 200 may not be hollow and is filled with materials and/or components. As another example, the housing 200 may further comprise a part located near an un-depicted part of the head 20. Various components may be disposed in the housing 200 based on an overall design or overall architecture, and hence each of the components occupies a corresponding space in the housing 200. Components other than the antenna structure 100 are not depicted in FIGS. 1a and 1b for simplicity of illustration.

In these embodiments, the antenna structure 100 occupies a space in the housing 200. The antenna structure 100 is located at a portion A of the housing 200, and the portion A protrudes away from a head 20 of a user when the head-mounted electronic device 10 is worn by the user. Herein a manner of the user wearing the head-mounted electronic device 10 depends on a type of the head-mounted electronic device 10. Generally, the user wearing the head-mounted electronic device 10 means that at least a part of the housing 200 contacts the at least a part of the user's head, so that the housing 200 is fixed or substantially fixed on the head or near the head. As an example, the head-mounted electronic device 10 is in a form of eyeglasses, and the housing 200 contacts users'ears through temple bars and contacts the user's nose through nose pads. As another example, the head-mounted electronic device 10 is a helmet, and the housing 200 at least contacts the top of the head. As another example, the head-mounted electronic device 10 is a head-mounted camera, and the housing 200 may contacts the forehead, parietal ridge, or the crown of the head. Generally, a manner of the wearing can be determined as long as the type the head-mounted electronic device 10 is known. In very rare applications, there is more than one manner of wearing the head-mounted electronic device 10. In such case, the manner of wearing refers to a manner in which normal operation of the worn head-mounted electronic device 10 adopts the antenna structure 100 to implement wireless communications. The part of the housing 200 which contacts the head 20 is not depicted in FIGS. 1a and 1b for clear illustration.

As shown in FIGS. 1a and 1b, a contour of the head of the user is indicated by a dashed curve, the portions are indicated by dotted circles, and the antenna structure 100 is indicated by black blocks located in the dotted circles. In some embodiments, there are multiple protrusions that points away from the head 20 in the housing 200, and the portion A may refer to any of these protrusions. As an example, the housing 200 in FIG. 1 have at least three qualified protrusions, and hence there may be three candidate portions (which are denoted as A, A′, and A″, respectively). Correspondingly, although only the portion A is depicted with the black block in Figure la, the antenna structure 100 may be located in any of the three candidate portions A, A′, and A″. As another example, the housing 200 in FIG. 1b have at least two qualified protrusions, and hence there may be two candidate portions (which are denoted as portions A and A′, respectively). Correspondingly, although only the portion A is depicted with the black block in FIG. 1b, the antenna structure 100 may be located in either of the two candidate portions A. In some embodiments, the antenna structure 100 is disposed in a candidate region having a larger distance to a skin of the user, that is, a candidate region which is farther from the head 20 of the user. Taking Figure la as an example, the candidate portion A has a larger distance to the head 20 than the candidate portions A′ and A″, and hence is more preferable than the other two for accommodating the antenna structure 100. Taking FIG. 1 b as another example, the candidate portions A and A′ have identical distances to the head 20, and hence there may be no preference between the two portions. In one embodiment, a candidate region having a largest distance to the head 20 among all candidate regions is selected. That is, when the head-mounted electronic device 10 is worn by the user, the portion A at which the antenna structure is located is farthest from a head of a user among all portions which protrude away from the head in the housing.

Moreover, the antenna structure 100 located at the portion A may refer to the antenna structure which is located in a cavity in the housing 200 at the portion A, attached on a surface of the housing 200 at the portion A, embedded in the housing 200 at the portion A, or inlaid on the housing 200 at the portion A. That is, the antenna structure may or may not be exposed at the housing 200. An appropriate configuration may be selected based on an application scenario of the head-mounted electronic device 10.

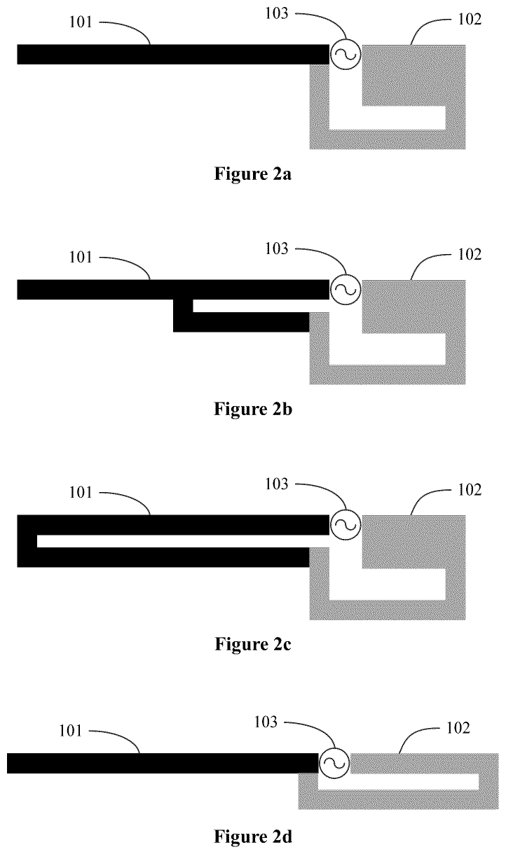

Those skilled in the art can appreciate that the schematic structural diagrams in FIGS. 1a and 1b are views of the head-mounted electronic device 10 along a certain direction, and such direction is not limited herein. That is, the direction may be forward, backward, upward, downward, leftward, rightward, or any other possible directions. Moreover, it is noted that the black blocks in FIGS. 1a and 1b are used only for simplicity of illustration, and does not indicate that a shape of the antenna structure 100 is limited to a rectangle when viewed from the direction. In practice, the antenna structure 100 may have various shapes and configurations, for example, as shown in FIGS. 2a to 2d.

As discussed above, there are various frequency bands and various wireless communication standards for the wireless signals. In order to expand application scenarios of wireless electronic devices, it is desirable that an antenna structure supports wireless communications under multiple frequency bands and/or multiple standards. That is, the antenna structure contains more than one antenna, which occupies larger space in comparison with a single antenna. In such case, the multiple antennas may be disposed at different aforementioned candidate portions to ensure desirable quality of wireless signals at each antenna. Such design requires separate feeds distributed among the multiple candidate portions, which may engender complex wiring in the head-mounted electronic device. In order to simplify the wiring and improve robustness of the antenna structure, or when there is only one qualified protruding portion in the housing, it is preferable that the multiple antennas are disposed at the same protruding portion. Since the antenna structure is located at the protruding portion of the housing, a space for accommodating the antenna structure is limited, especially when compared with a flat or substantially flat portion. That is, the limited space at the portion A needs to be utilized more fully by the antenna structure 100 supporting the multiple frequency bands and/or multiple standards. In order to address at least the above issue, hereinafter architecture of the antenna structure is illustrated in conjunction with some embodiments.

In one embodiment, the antenna structure 100 comprises a first electrode 101 and a second electrode 102. The first electrode is located at one side of a feeding point 103, and the second electrode is located at another side of the feeding point 103. The first antenna and the second antenna sharing the same feeding point while locating at different sides of the feeding point are capable to reduce a space occupied by the antenna structure 100 to the most extent while ensuring quality of wireless signals. The first electrode 101 serves as at least a part of a first antenna fed from the feeding point 103, and the second electrode 102 serves as at least a part of a second antenna fed from the feeding point 103. The first antenna and the second antenna are configured to transmit or receive wireless signals of different frequencies.

In the above architecture, the first antenna and the second antenna sharing the same feeding point 103 are located at different sides of the feeding point 103. Since the feeding point 103 is shared between the two antennas, it is not necessary to provide separate feeds in the limited space of the portion A, which reduces spatial occupation of the antenna structure. Moreover, the first antenna 101 and the second antenna 102 which are disposed at different sides of the feeding point would enhance a spatial distance between the two antennas and reduce interferences between wireless signals for different frequencies, thereby improving quality of the wireless communication. As an example, it is assumed that the wireless signals transmitted or received by the first antenna have a first frequency, while those transmitted or received by the second antenna have a second frequency. The first electrode 101 and the second electrode 102 may be disposed at opposite sides of the feeding point 103. The opposite sides may be a left side and a right side in a two-dimension plane, as shown in FIGS. 2a to 2d. In one aspect, the different-side arrangement ensures little mutual capacitance and little mutual inductance between the two electrodes (i.e. between the two antennas). In another aspect, only few electromagnetic waves transmitted from the first antenna (i.e., the first electrode 101) would propagate through the second electrode 102, and only few electromagnetic waves transmitted from the second antenna (i.e., the second electrode 102) would propagate through the first electrode 101. Therefore, the wireless signals from both antennas are subject to little attenuation.

Herein the first electrode 101 may be the sole electrode of the first antenna, that is, the first antenna only transmits and receives corresponding wireless signals via the electrode 101. Alternatively, the first electrode 101 may serve as partial the first antenna, and there is an additional electrode electrically connected to the first electrode 101 and operating in conjunction with the first electrode 101 when the first antenna transmits or receives the corresponding wireless signals. The additional electrode may be located at or adjacent to the portion A, and may be fixedly or detachably attached to the housing 200. Similarly, the second electrode 102 may serve as the sole electrode of the second antenna or partial second antenna. The present disclosure is not limited to any specific case as discussed above, as long as the first electrode and the second electrode participate in transmission or reception of wireless signals of different frequencies.

Herein the first electrode 101 and the second electrode 102 located at different sides of the feeding point 103 may refer to a part of the first electrode is located at one side while a part of the second electrode 102 is located at another side. Another part of the first electrode 101 may be located at the same side as the part of the second electrode 102, and another part of the second electrode 102 may be located at the same side as the part of the first electrode 101. In practice, the first electrode 101 and the second electrode 102 may be physically separated electrodes, for example, when both are monopolar antenna. Alternatively, the first electrode 101 and the second electrode 102 may be sub-electrodes which are adjacent or overlap with each other in an integral electrode (which may be called a macro-electrode). In such case, the macro-electrode serves the part of the first antenna when the antenna structure transmits or receives the wireless signals of a first frequency, and serves the part of the second antenna when the antenna structure transmits or receives the wireless signals of a second frequency. Although the first electrode 101 and the second electrode 102 are shaded in black and gray, respectively, in FIGS. 2a to 2d, they may be located in the same macro-electrode or may be two overlapping physically separate electrodes.

In some embodiments, the first antenna and the second antenna are not only configured to transmit or receive wireless signals of different frequencies, but also of different antenna types. Herein the different types mainly concern the shapes of the antennas. That is, the first antenna and the second antenna may have different shapes irrespective a dimension determined by the frequency of the corresponding wireless signals. Herein the different antenna types may include a monopolar antenna, a slot antenna, a loop antenna, an inverted-L antenna, an inverted-F antenna, a meander antenna, and the like, which is not specifically limited herein. A shape of the first electrode 101 is the shape of the first antenna when the first antenna merely comprises the first electrode, and a shape of the second electrode 102 is the shape of the second antenna when the second antenna merely comprises the second electrode. Reference is made to FIGS. 2a to 2d, which show schematic structural diagrams of antenna structures 100 according to embodiments of the present disclosure, where each of the first antenna and the second antenna comprises only the first electrode 101 and the second electrode 102, respectively. In FIG. 2a, the first antenna is a monopolar antenna, and the second antenna is a slot antenna. In FIG. 2b, the first antenna is an inverted-F antenna, and the second antenna is a slot antenna. In FIG. 2c, the first antenna is a loop antenna, and the second antenna is a slot antenna. In FIG. 2d, the first antenna is a monopolar antenna, and the second antenna is a loop antenna. It is appreciated that FIGS. 2a to 2d merely show some exemplary combinations of different antenna types, and the present disclosure is not limited thereto. The different antenna types is capable to provide more flexible adaptability of the antenna structure 100 to the limited space of the protruding portion A, and hence allows those skilled in the art to select appropriate combination according to various actual conditions. The possible combinations are not enumerated herein for brevity. Moreover, in practice, the first electrode 101 and the second electrode 102 may not be located in a two-dimensional plane, but may be curved, folded, or twisted with a certain angle, which is also determined according to an actual condition such as a shape of the protruding portion A.

It is appreciated that the first antenna and the second antenna sharing the same feeding point 103 form a dual-band antenna structure. In some embodiments, the antenna structure 100 supports more than two frequency bands. The additional frequency band may be supported by providing more antennas fed by the feeding point 103, for example, by connecting one or more additional electrodes to the feeding point 103. The additional antenna may have an antenna type identical to that of the first antenna or the second antenna 102, or may have an antenna type different from those of the first antenna or the second antenna, which is not limited herein and may be determined based on an actual condition of the protruding portion A.

The first electrode 101 and the second electrode 102 may be conductive films, conductive sheets, or conductive lines, and may be implemented in various forms. In one embodiment, the first electrode 101 and/or the second electrode 102 may be located on a metal frame. In another embodiment, the first electrode 101 and the second electrode 102 may be located on a flexible printed circuit (FPC). For example, the first electrode 101 and the second electrode 102 may be metallic patterns printed on a flexible film. The flexible film may be directly or indirectly attached to the protruding portion A of the housing 200, or may serve as an intermediate substrate for transferring the metallic patterns to the protruding portion A. In another embodiment, the first electrode 101 and the second electrode 102 may be integrated in a molded interconnected device (MID) of another technique. For example, the first electrode 101 and the second electrode 102 may be metallic patterns formed on a doped thermoplastic material through a laser direct structuring (LDS) process, that is, located on a laser-direct-structured material. Moreover, these elements may be directly printed on the protruding portion A of the housing 200 through, for example, the LDS. In such case, at least a part of the protruding portion A may be a thermoplastic material or glass doped with metallic inorganic compound. It is appreciated that the MID may be implemented through other suitable techniques, which are not enumerated herein. When being the conductive film or the conductive sheet, the first electrode 101 and the second electrode 102 may be disposed in parallel with, in perpendicular to, or with an arbitrary angle to a surface of the housing 200. In some embodiments, at least a part of the first electrode 101 and/or at least a part of the second electrode 102 may be directly printed on the housing 200.

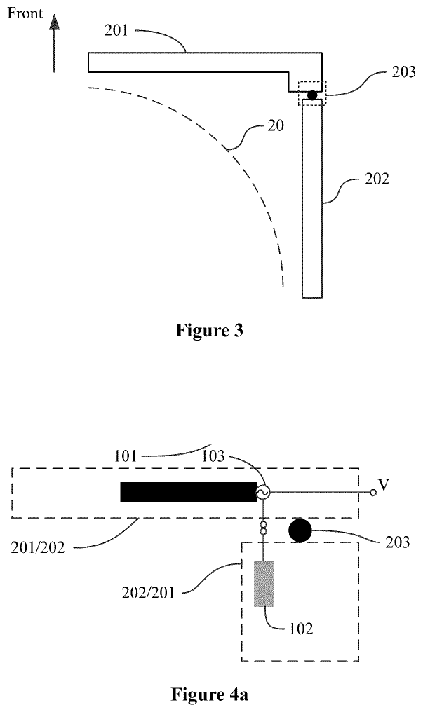

Reference is made to FIG. 3, which is a schematic structural diagram of a housing of a head-mounted electronic 10 when being worn by a user according to an embodiment of the present disclosure. In this embodiment, the housing 200 comprises a first component 201 and a second component 202. When the head-mounted electronic device 10 is worn by the user, the first component 201 is disposed in front of the head 20 of the user, and the second component 202 is disposed at either right or left of the head 20. An end of the first component 201 and an end of the second component 202 are physically connected at a junction 203, and the junction 203 serves as the portion A of the housing 200. That is, the housing 200 has a part running over both the front and the left, or both the front and the right of the head 20, and the antenna structure 100 is located at the right-front or the left-front of the head 20. Herein the junction 203 refers to a part of the housing 200 at which the first component 201 and the second component 202 are connected to each other. The junction 203 may comprise an independent physical component, such as a joint or a pivot connecting the first component 201 and the second component 202. As shown in FIG. 3, the junction 203 is a region indicated by a dashed square, and comprises a pivot indicated by a black dot between the first component 201 and the second component 202. In such case, the housing 200 is generally flexible at the junction 203. For example, the first component 201 and the second component 202 may be folded toward each other via the junction 203. Alternatively, the junction 203 may refer to a part of the housing 200 which forms an integral component along with the first component 201 and the second component 202. In such case, the housing 200 may be either flexible at the junction 203 (for example, the junction 203 having an elastic material) or inflexible at the junction 203 (for example, the junction 203 having a rigid material). It is appreciated that the housing 200 may have a component other than the first component 201 and the second component 202.

In some embodiments, the junction 203 does not have a protruding portion in the housing 200, as shown in FIG. 3. That is, the junction 203 does not serve as the portion A of the housing 200, and the antenna structure is not located at the junction 203. In other embodiments, the junction 203 is provided with the protruding portion (for example, the junction 203 in FIG. 3 is shifted toward the upper-right corner). That is, the junction 203 may serve as the portion A of the housing 200. In such case, the portion A may be located at the junction 203 when the junction 203 is flexible, which facilitates controlling the electrical connection within the antenna structure 100. Since the junction is flexible, an angle between a surface of the first component 201 and a surface of the second component 202 is changeable. The change may be induced by manual force from the user, through a motor controlled by a processor or a control key, through thermal expansion of the material at the junction 203, or the like. For example, the head-mounted electronic device 10 is eyeglasses, the first component 201 and the second component 202 are a lens frame and a temple bar of the eyeglasses, and the angle between the lens frame and the temple bar changes when the user folds the eyeglasses. In one embodiment, the angle between the surface of the first component 201 and the surface of the second component 202 is detected by a detector. The detector may be capable to determine a specific value of the angle, or may be capable to determine a range in which the angle is located, which is not limited herein.

In one embodiment, the head-mounted electronic device 10 may further comprise an RF circuitry, which is configured to the first antenna and the second antenna via the feeding point 103. The RF circuitry is electrically connected to the feeding point 103, and may refer to the foregoing description for more details. The RF circuitry is electrically connected to at least one of the first antenna and the second antenna in a case that the angle between the surface of the first component 201 and the surface of the second component 202 being within a first range, and is electrically disconnected from the at least one of the first antenna and the second antenna in a case that the angle is not within the first range. That is, connection between the RF circuitry and one or both of the first electrode 101 and the second electrode 102 can be controlled through such angle. Electronic eyeglasses are further used as an example. In a case that the eyeglasses is folded, i.e., an angle between the lens frame and the temple bar is small, the connection between the feed and one or both of the two electrodes may be disconnected to disabled at least a part of wireless communications to, for example, reduce energy consumption. In a case that the eyeglasses is unfolded, for example, when being worn by the user, the angle is large, and the feed and one or both of the two electrodes are connected to enable the wireless communications.

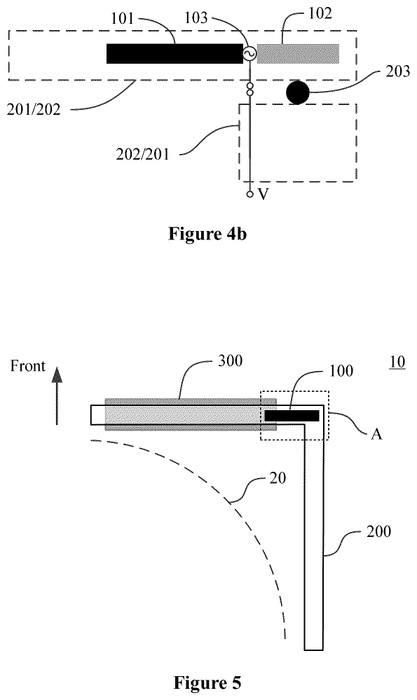

In one embodiment, one of the first electrode 101 and the second electrode 102 is disposed at the end of the first component 201, and another of the first electrode and the second electrode is disposed at the end of the second component 202. In such case, the junction 203 may be configured to control connection between the feeding point 103 and either the first antenna or the second antenna. Reference is made to FIG. 4a, which is a schematic structural diagram of an antenna structure disposed in a housing according to an embodiment of the present disclosure. As shown in FIG. 4a, one of the first component 201 and the second component 202 is provided with the first electrode 101 and the feeding point 103, and the other is provided with the second electrode 102. The RF circuitry provides an oscillating voltage, which is denoted by V, to the feeding point 103. The contact between the feeding point 103 and the second electrode 102 is denoted by two adjacent circles, and is connected as shown in FIG. 4a. In such case, both the first antenna and the second antenna are fed by the RF circuitry via the feeding point, and hence are capable to implement wireless communications. When the component having the second electrode 102 rotates counterclockwise with respect to the component having the first electrode 101 and the feeding point 103, the contact would be disconnected and the second antenna cannot get a feed from the RF circuitry, and hence the second antenna is incapable to implement wireless communications. Thereby, separate control on a wireless function of the second antenna can be achieved through the junction 203. It is appreciated that the feeding point 103 may be alternatively be disposed at a side of the second electrode 102, that is, one of the first component 201 and the second component 202 is provided with the first electrode 101, and the other is provided with the second electrode 102 and the feeding point 103, such that separate control on a wireless function of the first antenna can be achieved through the junction 203. It is further appreciated that the feeding point 103 may be alternatively be disposed at neither the end of the first component nor the end of the second component 202, but at an intermediate portion between such two ends, such that separate control on wireless functions of both the first antenna and the second antenna can be achieved through the junction 203.

In other embodiments, both the first electrode 101 and the second electrode 102 are disposed at the end of the first component 201, or disposed at the end of the second component 202. In such case, the junction 203 may be configured to control connection between the feeding point 103 and both antennas. Reference is made to FIG. 4b, which is a schematic structural diagram of an antenna structure disposed in a housing according to another embodiment of the present disclosure. As shown in FIG. 4b, either the first component 201 or the second component 202 is provided with the first electrode 101, the second electrode 102, and the feeding point 103, and the other is provided with an electrical path configured to connect the feeding point 103 to the RF circuitry. The contact between the feeding point 103 and the RF circuitry is denoted by two adjacent circles, and is connected as shown in FIG. 4b. In such case, both the first antenna and the second antenna are fed by the RF circuitry via the feeding point, and hence are capable to implement wireless communications. When the component having the path rotates counterclockwise with respect to the component having the two electrodes and the feeding point 103, the contact would be disconnected, both the first antenna the second antenna cannot get a feed from the RF circuitry, and hence neither the first antenna nor the second antenna is capable to implement wireless communications. Thereby, simultaneous control on wireless functions of the first antenna and the second antenna can be achieved through the junction 203.

In some embodiments, the first electrode 101 is located within a plane parallel with or perpendicular to a surface of the housing 200, and/or the second electrode 101 is located within the plane, or another plane, which is parallel with or perpendicular to the surface of the housing 200. Generally, the surface of the housing refers to a portion of the housing that is closest to the first electrode 101 and/or the second electrode. It is appreciated that the portion corresponding to the first electrode 101 may be different from, or identical to the portion corresponding to the second electrode 102.

Reference is made to FIG. 5, which is a schematic structural diagram of a head-mounted electronic device when being worn by a user according to another embodiment of the present disclosure. As shown in FIG. 5, the head-mounted electronic device 10 further comprises a lens 300 disposed in front of an eye of the user when the head mounted electronic device 10 is worn by the user, and the antenna structure 100 is located adjacent to the lens 300. Herein the antenna structure 100 located adjacent to the lens 300 may refer to the antenna structure 100 located directly adjacent to the lens 300, for example, attached to the lens 300 or abutting against the lens 300, or located in proximity to the lens 300, for example, near the lens 300 but is apart from the lens 300 by a narrow gap or a thin material layer. In one embodiment, the housing 200 comprises a lens frame 301, which is configured to fix the lens 300 to the housing 200, and at least a part of the antenna structure is attached to the lens frame 301. Herein the lens frame 301 may surround the lens 300, or may be arranged along only partial periphery of the lens 300. The lens 300 may be fixedly or detachably connected to the lens frame 301, and may be replaced by another lens 300 when necessary. In some embodiments, there may be no lens frame and the lens is directly connected to the housing at one or more points along its periphery. The part attached to the lens frame 301 in the antenna structure 100 may refer to the first electrode 101, the second electrode 102, or both of the two electrodes. In some embodiments, the first electrode 101 or the second electrode 102 is not attached to the lens frame 301. In some embodiments, the attachment between the lens 300 or the lens frame 301 and the first electrode 101 or the second electrode 102 may refer to that the corresponding electrode is printed on the lens 300 or the lens frame 301. In some embodiments, when being the conductive film or the conductive sheet, the first electrode 101 and the second electrode 102 may be disposed in parallel with, in perpendicular to, or with an arbitrary angle to a surface of the lens 300 or a surface of the lens frame 301. In other embodiments, the first electrode 101 and the second electrode 102 may be embedded in the lens 300 or a surface of the lens frame 301.

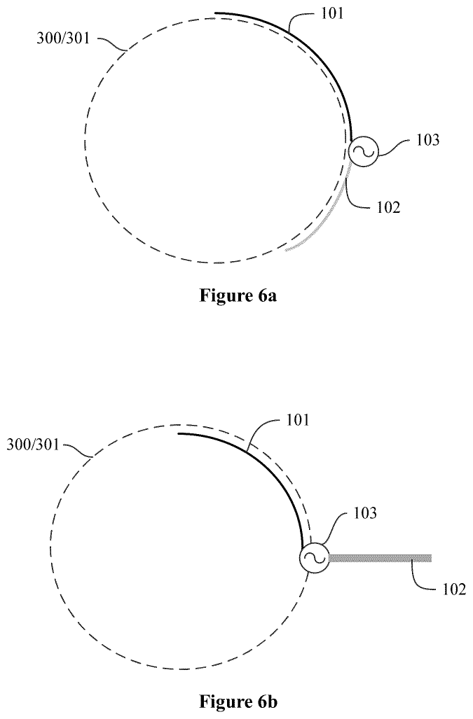

Both the lens 300 and the lens frame 301 may provide a region to dispose the antenna structure 100, especially the first electrode 101 and/or the second electrode 102. That is, the housing 200 in proximity to the lens 300 or the part of the lens frame 100 may serve as a part of the aforementioned protruding portion A. Reference is made to FIGS. 6a and 6b, which are schematic structural diagrams of an antenna structure disposed at a lens or a lens frame according to embodiments of the present disclosure. In some embodiments, at least a part of the first electrode 101 is disposed adjacent to the lens 300, and is conformed to an edge of the lens 300 or to the lens frame 301. That is, the part of the first electrode 101 or the whole first electrode 101 has a shape identical or substantially identical to a part of the edge of the lens 300, or to a part of the lens frame 301. Hence, the first electrode 101 may fully utilize the housing 200 adjacent to the lens 300, such as the lens frame 301. Such configuration is capable to further save space in the housing 200 and render the whole head-mounted electronic device more compact, and is especially beneficial when the first electrode 101 is shaped as a long stripe, for example, as shown in FIG. 2a to 2d.

Similar to the first electrode 101, at least a part of the second electrode 102 may be disposed adjacent to the lens 300, and is conformed to an edge of the lens 300 or to the lens frame 301, so as to further save the limited space provide at the protruding portion A. In such case, both the part of the second electrode 102 and the part of the first electrode 101 extend along the edge or the lens frame, but extend in different directions to reduce interference between the two antennas. As shown in FIG. 6a, the first electrode 101 extends along an upper edge of the lens 300 or an upper part the lens frame 301, while the second electrode 102 extends along a lower edge of the lens 300 or a lower part of the lens frame 301, and the feeding point 103 may be located at an intermediate part of the edge or the lens frame 301. It is appreciated that the feeding point 103 may be located not on the edge or the lens frame 301 when an end of the first electrode 101 or the second electrode 102, which is connected to the feeding point 103, is not conformed to the edge or the lens frame. It is further appreciated the first electrode and the second electrode 102 may have other configurations and not extend along the edge or the lens frame 301. For example, at least one of the first electrode 101 and the second electrode 102 extends long a surface of the lens 300, that is, is conformed to a surface of the lens 300. As shown in FIG. 6b, the first electrode 101 extends a surface of the lens 300 near the upper edge, while the second electrode 102 extends away from the lens 300 or the lens frame 301. Herein the portion at which the first electrode 101 or the second electrode 102 is disposed is not specifically limited, as long as the electrode(s) does not cause a severe occlusion to a view field of the eye behind the lens. In some embodiments, the first electrode 101 and/or the second electrode 102 is made of a transparent material or semi-transparent material, and hence may even extend toward a central region of the lens 300. Although the lens 300 or the lens frame 301 are illustratively depicted as dashed circles in FIGS. 6a and 6b, those skilled in the art can appreciate that they may have other appropriate shapes in practice.

Herein the first electrode 101 or the second electrode 102 extending along the edge or the surface of the lens 300 may or may not contact the lens 300. That is, the electrode(s) may be attached to the lens 300, or may be separated from the lens by a gap. Similarly, the first electrode 101 or the second electrode 102 may or may not contact the lens frame 301. For example, the electrodes(s) may be embedded or attached to the lens frame 301, or may be located in a cavity provided in the lens frame 301. Similar to what is discussed above, the first electrode 101 and the second electrode 102 when being the conductive film or the conductive sheet may be disposed in parallel with, in perpendicular to, or with an arbitrary angle to a surface of the lens or the lens frame, which is not limited herein.

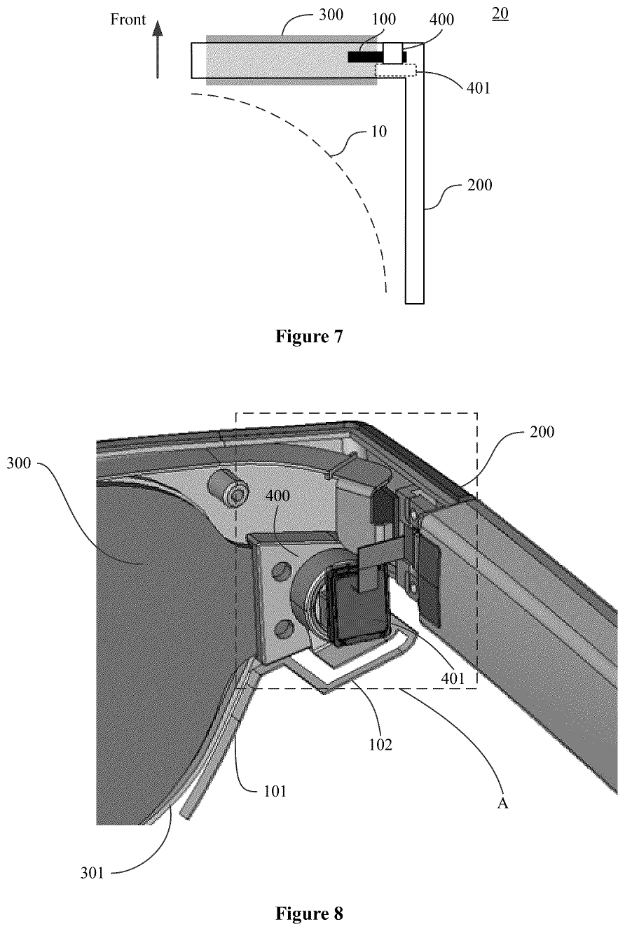

Reference is further made to FIG. 7, which is a schematic structural diagram of a head-mounted electronic device when being worn by a user according to another embodiment of the present disclosure. On a basis of the structure as shown in FIG. 5, the head-mounted electronic device 10 further comprises a conductive bracket 400, which is configured to mount a functional apparatus 400 on the housing 200. The antenna structure 100 is attached to the housing 200 via the conductive bracket 400, and the conductive bracket 400 serves as a ground for the first antenna and the second antenna. That is, a supporting member is reused as the ground of the antenna structure, which further reduces spatial occupation within the housing 200 and improves compactness of the head-mounted electronic device 10. A specific shape of the conductive bracket 400 is not limited herein, and may be determined based on a specific form of the functional apparatus 400 in practice. Generally, the conductive bracket 400 is implemented as a conductive piece, which is folded into a shape that is capable for fixing the functional apparatus 401 to the housing 400. In some embodiments, the conductive bracket 400 is connected to a common ground for circuitry and components in the head-mounted electronic device 10. Although the conductive bracket 400 is depicted on a layer over the antenna structure 100, a specific positional relationship between the two is not specifically limited herein, as long as the first antenna and the second antenna are grounded via the conductive bracket 400.

The functional apparatus 400 may be implemented in various forms. As example, the functional apparatus may comprise a projector configured to project an image onto the lens 300. In such case, the antenna structure 100 may be disposed at a side of the projector other than the side of the projector facing the lens 300, so as to avoid block a path of the light. As another example, the functional apparatus may comprise a camera, a sensor, a speaker, a connecting interface, a battery, or the like, which is not specifically limited herein. The functional apparatus 400 may be an intrinsic or internal component of the head-mounted electronic device 10, or may be an external component that is detachably connected to the head-mounted electronic device 10. In the latter case, the conductive bracket 400 may serve as a connecting interface for the functional apparatus 400, and the functional apparatus 400 may be replaced with another apparatus that is adapted to the connecting interface. Although the functional apparatus 401 is depicted at a side facing the head of the conductive bracket 400, a specific positional relationship between the functional apparatus 401 and the conductive bracket 400 is not specifically limited herein.

In some other embodiments, the antenna structure 100 is directly attached to a conductive portion of the housing 200, and the conductive portion serves as a ground for the first antenna and the second antenna. Generally, the conductive portion is a part of the protruding portion A of the housing. Such configuration is beneficial when the protruding portion A has limited space which may not be capable to dispose the conductive bracket 400 and/or the functional apparatus 401 in such portion. In one embodiment, the conductive portion may located out of the protruding portion A, and a conductive wire or a lead is connected between the conductive portion and the antenna structure 10 to achieve grounding. It is appreciated that the antenna structure 10 may alternatively be grounded in other forms, for example, be directly connected to a common ground within the head-mounted electronic device 10.

Hereinafter illustrated is a more specific embodiment of the head-mounted electronic device 10. Reference is made to FIG. 8, which is a schematic stereoscopic view of a part of a head-mounted electronic device according to an embodiment of the present disclosure. In this embodiment, the head-mounted electronic device 10 is electronic eyeglasses, the first component 201 of the housing 200 comprises the lens frame 301 for the lens 300 disposed in front of the right eye of the user when the user wears the eyeglasses, and the second component 202 is the right temple bar of the eyeglasses. There is a protrusion pointing a right-front side of the head at the housing 200, which is right at a region of the pivot between the lens frame and the right temple bar. A conductive bracket 400, for example, a metal bracket, is disposed at the protrusion and between the right edge of the lens 300 and the pivot. The conductive bracket fixes a projector 400 onto the housing 200, and is provided with a circular aperture is right front of the projector 400, such that the projector 400 is capable to project light onto the lens 300 via, for example, an optical system. The antenna structure 100 is disposed below the projector 401 and the conductive bracket 400. Specifically, the first electrode 401 and the second electrode 102 form an integral conductive sheet, such as a piece of metal, connected to the conductive bracket 400 for grounding. The first electrode 101 extends leftward from the conductive bracket 400 along a lower portion of the lens frame 301, and the first antenna is a monopolar antenna. The second electrode is located right below the projector, and the second antenna is a slot antenna. A location of the feeding point 103 (not depicted) may refer to FIG. 2a, and is below the conductive bracket 400 and between the first electrode 101 and the second electrode 102. The feeding point 103 is electrically connected to the RF circuitry (not depicted) of the electronic eyeglasses. It is noted that the conductive bracket 400, the projector 401, and the antenna structure are depicted to be exposed in FIG. 8 for clear illustration. In practice, a rear cap may be provided as a part of the housing 200 to cover one or more of these components for the sake of protection. Thereby, a dual-band antenna structure is provided in the electronic eyeglasses through efficiently utilize the limited space at the junction between the temple bar and the lens frame. In comparison with disposing the antenna structure at an intermediate part or a tip of the temple bar, the electronic eyeglasses adopting the above structure has better quality of wireless signals because a distance between the antennas and the head of the user is enlarged without significantly putting additional burden (i.e. additional weight or addition accessories of the eyeglasses) to the user.

As discussed above, the shape and the dimensions of the first electrode 101 and the second electrode 102 may be tuned to implement wireless communication in various frequency bands. In one experiment, the first electrode 101 and the second electrode 102 in the electronic eyeglasses adopts a shape as shown in FIG. 2a. The first antenna is a monopolar antenna of which a length is 25 mm and the width is 1.5 mm. The second antenna is a slot antenna, of which a width (height in FIG. 2 a) is 7.5 mm and a length is 11.5 mm. The L-shaped slot has a height of 5.6 mm and a length of 9.5 mm, and has a uniform width of 2 mm along the stroke of the letter “L”. The left bar and the bottom bar at the peripheral of the slot has a uniform width of 1 mm. Results of the experiment shows that the dual-band antenna structure has good antenna characteristics for wireless signals of 2.44 GHz and 5.5 GHz, which are quite common in, for example, the Bluetooth™ and the Wi-Fi standards.

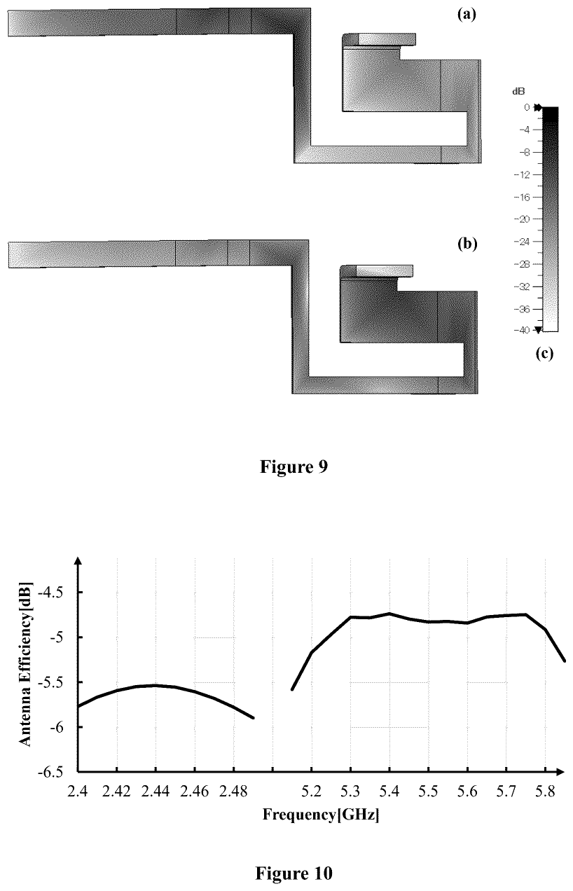

Reference is made to FIG. 9, which is a current distribution of such antenna structure under feeds having frequencies of 2.44 GHz and 5.5 GHz, respectively. In FIG. 9, subfigure (a) shows current distribution corresponding to the 2.44 GHz feed, subfigure (b) shows current distribution corresponding to the 5.5 GHz feed, and subfigure (c) shows a reference bar for relative current strength in subfigures (a) and (b). It is apparent that strong currents is confined in the first electrode 101, i.e., the first antenna in case of the 2.44 GHz feed and in the second electrode 102, i.e., the second antenna in case of the 5.5 GHz feed. Hence, there is little interference between the two antennas during the wireless communication within the two frequency bands. Reference is further made to FIG. 10, which shows antenna efficiency of the electronic eyeglasses having such antenna structure throughout the two frequency bands. It can be seen that the antenna efficiency stays above −6 dB throughout 2.40 GHz to 2.49 GHz and reaches −5.5 dB around 2.44 GHz in one frequency band, and are smooth and stays above 5 dB in throughout 5.25 GHz to 5.8 GHz in another frequency band, which provides quite idea quality for wireless signals.

It is appreciated that the foregoing eyeglasses and the foregoing experiments on specific configuration of the antenna structures are merely examples. The head-mounted electronic devices may be implemented in other forms, such as a helmet, a monocle, goggles, a headband, or a VR/AR headset. The lens and the functional apparatus may also be implemented in other forms. For example, an electronic helmet may have a mask to bear the image projected from the projector, or other eyeglasses may have a camera located at a right-front or left-front corner for capturing images. Moreover, the first electrode and the second electrode may have other shapes or dimensions, for example, those as shown in FIGS. 2b to 2d, to adapt to other frequency bands or wireless standards.

An antenna structure is further provided according to embodiments of the present disclosure. The antenna structure comprises a first electrode located at a side of a feeding point, and a second electrode located at another side of a feeding point. The first electrode serves as at least a part of a first antenna fed from the feeding point, the second electrode serves as at least a part of a second antenna fed from the feeding point, and the first antenna and the second antenna are configured to transmit or receive wireless signals of different frequencies. Details of the antenna structure may refer to the foregoing description concerning the head-mounted electronic device, and are not repeated herein. Those skilled in the art can appreciate that the beneficial effects achieved by an antenna structure in the head-mounted electronic device applies mutatis mutandis herein.

The schematic diagrams in the Figures illustrate the architecture, functionality, and operation of possible implementations of systems according to various embodiments. In this regard, the architecture, functionality, and operation of possible implementations of systems may include additional components, fewer components, different components, or differently arranged components than those depicted in the Figures.

In specification, claims, and drawings of the present disclosure, the terms “first”, “second”, and the like are intended to distinguish similar objects but do not necessarily indicate a specific order or sequence. It should be understood that data described in such manner is interchangeable where appropriate, so that embodiments of the present disclosure described herein may be implemented in an order other than that is illustrated or described herein. Moreover, the terms “include”, “comprise”, and any other variants thereof are intended to cover non-exclusive inclusion. For example, a process, a method, a system, a product, or a device that includes a list of steps or units is not necessarily limited to these expressly listed steps or units, but may include another step or another unit that is not expressly listed or that is inherent to such process, method, system, product, or device. No element, act, or instruction used herein should be construed as critical or essential unless explicitly described as such. Also, as used herein, the articles “a” and “an” are intended to include one or more items, and may be used interchangeably with “one or more”. Furthermore, as used herein, the term “set” is intended to include one or more items (e.g., related items, unrelated items, a combination of related and unrelated items, etc.), and may be used interchangeably with “one or more”. Where only one item is intended, the term “one” or similar language is used. Also, as used herein, the terms “has”, “have”, “having”, or the like are intended to be open-ended terms. Further, the phrase “based on” is intended to mean “based, at least in part, on” unless explicitly stated otherwise.

The embodiments of the present disclosure are described in a progressive manner, and each embodiment places emphasis on the difference from other embodiments. Therefore, one embodiment can refer to other embodiments for the same or similar parts.

According to the description of the disclosed embodiments, those skilled in the art can implement or use the present disclosure. Various modifications made to these embodiments may be obvious to those skilled in the art, and the general principle defined herein may be implemented in other embodiments without departing from the spirit or scope of the present disclosure. Therefore, the present disclosure is not limited to the embodiments described herein but confirms to a widest scope in accordance with principles and novel features disclosed in the present disclosure.

1. A head-mounted electronic device adapted to be worn by a user, comprising:
an antenna structure, configured to transmit and/or receive wireless signals, and
a housing, wherein the antenna structure is located at a portion of the housing, and the portion is configured to protrude away from the head of the user.

2. The head-mounted electronic device according to claim 1, wherein the portion is configured to be farthest from the head of the user, among a local part of the housing where the portion is located.

3. The head-mounted electronic device according to claim 2, wherein:
the portion is configured to be farthest from the head of the user, among all portions which are configured to protrude away from the head in the housing.

4. The head-mounted electronic device according to claim 1, wherein the antenna structure comprises:
a first electrode, located at a first side of a feeding point; and
a second electrode, located at a second side of the feeding point;
wherein the first electrode serves as at least a part of a first antenna fed from the feeding point, the second electrode serves as at least a part of a second antenna fed from the feeding point, and the first antenna and the second antenna are configured to transmit and/or receive wireless signals of different frequencies.

5. The head-mounted electronic device according to claim 4, wherein the first antenna and the second antenna are different types of antenna.

6. The head-mounted electronic device according to claim 5, wherein the different types of antennas are selected from the group consisting of a monopolar antenna, a slot antenna, a loop antenna, an inverted-L antenna, an inverted-F antenna, and a meander antenna.

7. The head-mounted electronic device according to claim 4, wherein one or more of the first electrode and the second electrode are selected from the group consisting of conductive films located on a metal frame, a flexible printed circuit, and a laser-direct-structured material.

8. The head-mounted electronic device according to claim 4, wherein the housing comprises:
a first component configured to be in front of the head of the user; and
a second component configured to be at either a right or a left of the head;
wherein an end of the first component and an end of the second component are physically connected at a junction.

9. The head-mounted electronic device according to claim 8, wherein the junction serves as the portion of the housing.

10. The head-mounted electronic device according to claim 8, further comprising a radio-frequency (RF) chip, configured to feed the first antenna and the second antenna via the feeding point, wherein:
the housing is flexible at the junction;
the RF chip is electrically connected to at least one of the first antenna and the second antenna in response to an angle between a surface of the first component and a surface of the second component being within a first range; and
the RF chip is electrically disconnected from the at least one of the first antenna and the second antenna in response to the angle being not within the first range.

11. The head-mounted electronic device according to claim 8, wherein a first of the first electrode and the second electrode is disposed at the end of the first component, and a second of the first electrode and the second electrode is disposed at the end of the second component.

12. The head-mounted electronic device according to claim 11, wherein the feeding point is located between the end of the first component and the end of the second component.

13. The head-mounted electronic device according to claim 8, wherein both the first electrode and the second electrode are disposed at the end of the first component, or at the end of the second component.

14. The head-mounted electronic device according to claim 10, wherein the first electrode is located within a first plane parallel with or perpendicular to a surface of the housing, and the second electrode is located within the first plane or a second plane which is parallel with or perpendicular to the surface of the housing.

15. The head-mounted electronic device according to claim further comprising:
a lens configured to be disposed in front of an eye of the user;
wherein the antenna structure is adjacent to the lens.

16. The head-mounted electronic device according to claim 15, wherein the housing comprises a lens frame configured to fix the lens to the housing, and at least a part of the antenna structure is attached to the lens frame.

17. The head-mounted electronic device according to claim 16, wherein at least a part of the first electrode is disposed adjacent to the lens and is conformed to an edge of the lens or to the lens frame.
at least a part of the second electrode and the part of the first electrode extend along the edge or the lens frame in different directions.

18. The head-mounted electronic device according to claim 15, wherein at least one of the first electrode and the second electrode is conformed to a surface of the lens.

19. The head-mounted electronic device according to claim 4, further comprising:
a conductive bracket configured to mount a functional apparatus on the housing, wherein the antenna structure is attached to the housing via the conductive bracket, the conductive bracket serves as a ground for the first antenna and the second antenna.

20. An antenna structure, comprising:
a first electrode, located at a first side of a feeding point; and
a second electrode, located at a second side of the feeding point;
wherein the first electrode serves as at least a part of a first antenna fed from the feeding point, the second electrode serves as at least a part of a second antenna fed from the feeding point, and the first antenna and the second antenna are configured to transmit or receive wireless signals of different frequencies.
